(19) United States
(12) Patent Application Publication
(10) Pub. No.: US 2008/0159281 A1
(43) Pub. Date: Jul. 3, 2008

(54) Systems and Methods for Providing Hybrid Communication in a Transit Environment

(75) Inventor: Jason Jesseph, Broomfield, CO (US)

Correspondence Address: HENSLEY KIM & HOLZER, LLC, 1660 LINCOLN STREET, SUITE 3000, DENVER, CO, 80264, US

(73) Assignee: Level 3 Communications, Inc., Broomfield, CO (US)

(21) Appl. No.: 11/618,811

(22) Filed: Dec. 30, 2006

(51) Int. Cl. H04L 12/56

(52) U.S. Cl. 370/389

(57) ABSTRACT

Embodiments of systems and methods include an access point onboard a vehicle configured to communicatively connect one or more computers on the vehicle to a path-based communication line. The communication line is adjacent to, or on, a defined path, and connects the vehicle to a connection point to a metropolitan or backbone network. Signals sent to and from the vehicle-based computers may be in one format or protocol. Signals sent over the communication line may be in another format or protocol. Signals sent over the metropolitan network may be in yet another format or protocol. One or more devices onboard the vehicle and/or at the metropolitan network connection point can convert between signal formats and/or protocols.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006 Level 3 Communications, Inc.

### TECHNICAL FIELD

Embodiments of the present invention generally relate to network communications. More specifically, embodiments of the present invention relate to providing communication in a transit environment.

### BACKGROUND

Broadband connectivity has become ubiquitous in the home and office environments. Increasingly, broadband connectivity is also available in public areas, through Wi-Fi hotspot connectivity and 3G cellular networks. At the same time, end-users are more likely to travel with laptops, PDAs and phones with Wi-Fi capability. People increasingly expect to be able to use these devices where they are, and even while riding on board a vehicle such as a train.

Trains are a particularly attractive environment for commuters coming and going from work. Many passengers utilize time spent commuting on a train to complete work before they arrive to a meeting, in the office, or before they return home. For others, an Internet connection provides entertainment or a way to keep in touch with family and friends. Many commuters may spend an hour or more commuting to and from work. This is sufficient time to power up a laptop or other portable computing device, to check email, surf the Internet, or connect to a corporate network.

Train operators are increasingly aware of the operational advantages that data connectivity throughout the rail system offers. Ticketing, remote surveillance, safety, and management of in-car services (e.g., food service) are only a few of the applications that data connectively enables. A data connection along the tracks is no longer a convenience; rather, transit-based data connectivity is fast becoming a requirement.

Transit systems, however, pose unique requirements for broadband connectivity. For example, a train travels at sustained speeds and the connection has to be maintained throughout the journey. Trains cross urban areas, small cities, and rural areas. Each environment presents its own specific challenges. Solutions to these challenges should be cost-effective, so that the incentive exists for network operators to invest in providing network access in transit environments. Providing network connectivity to transit environments should be profitable to network operators. Current approaches do not effectively address the challenges of providing data connectivity in transit environments in ways that are cost-effective to network providers.

### SUMMARY

Embodiments of systems and methods include an access point onboard a vehicle configured to communicatively connect one or more computers on the vehicle to a path-based communication line. The communication line may be adjacent to, or on, a defined path, and connects the vehicle to a connection point to a metropolitan or backbone network. Signals sent to and from the vehicle-based computers may be in one format or protocol. Signals sent over the communication line may be in another format or protocol. Signals sent over the metropolitan network may be in yet another format or protocol. One or more devices onboard the vehicle and/or at the metropolitan network connection point can convert between signal formats and/or protocols.

A method for providing network communication in a transit environment includes receiving a wireless communication at a wireless access point on a passenger vehicle traveling on a defined path, reformatting the wireless communication into a wireline communication, and transmitting the wireline communication onto a path-based communication line that is adjacent to or on the defined path, wherein the wireline communication is transmitted to a network connection point that couples the path-based communication line to a metropolitan network, and wherein the network connection point is operable to transmit the communication onto the metropolitan network. When the passenger car is a train car, the path-based communication line may be a guide rail, a power rail, or an overhead power line. The method may further include communicating the wireline communication onto the path-based communication line via a coupling member that couples a transmitting device onboard the passenger car to the path-based communication line. In the case of a passenger train, the coupling member could be a dedicated electrically conductive device or one or more wheels of the passenger train. The wireline communication may further be formatted according to a protocol (e.g., a transit environment protocol) that is used on the path-based communication line in the transit environment.

Another embodiment of a method includes steps of receiving a wireless access protocol (WAP) formatted message at a wireless access point on a passenger vehicle traveling on a defined path, reformatting the WAP formatted message into a wireline protocol formatted message, and transmitting the wireline protocol formatted message onto a path-based communication line that is adjacent to or on the defined path, wherein the wireline protocol formatted message is transmitted to a network connection point that couples the path-based communication line to a metropolitan network, and wherein the network connection point is operable to transmit the message onto the metropolitan network.

The method may further include a step of reformatting the wireline protocol formatted message into a transit environment protocol formatted message. The transit environment protocol may be a variation of a broadband over power line (BPL) protocol. Reformatting the wireline message into the transit environment protocol may involve encapsulating the message in one or more transit environment protocol data fields. The method may further include steps of reformatting the transit environment protocol message into a metropolitan network protocol formatted message; and transmitting the metropolitan network protocol formatted message on the metropolitan network. Still further, the method may include removing the one or more transit environment protocol data fields from the transit environment protocol formatted message. The metropolitan network protocol may be selected from a group consisting of SONET and Ethernet.

The wireless access point may include a device that supports an IEEE 802.11 wireless communication standard. The passenger vehicle may include a passenger train car traveling on a train track that defines the path. In this case, transmitting the wireline protocol formatted message via the path-based communication line may include transmitting the wireline protocol formatted message via a path-based communication line selected from a group consisting of one or more guide rails of the train track, a power rail of the train track, or an overhead power line. Transmitting the wireline protocol formatted message onto a path-based communication line may involve transmitting the wireline protocol formatted message via an electrical conductor, such as a dedicated metallic structure, one or more wheels of the train car, and an overhead power line.

An embodiment of a system includes a communication line configured to carry electrical communications to and from the vehicle, the communication line being on or adjacent to the defined path, a first transceiver onboard the vehicle configured to receive communications sent from a computing device onboard the vehicle and transmit the communications on the communication line, and a second transceiver coupled to the communication and a metropolitan network, the transceiver configured to receive communications transmitted over the communication line and transmit the communications on the metropolitan network.

The system may further include a first media converter coupled to the first transceiver and configured to convert the communications from a first format used onboard the vehicle to a second format used on the communication line. The system may still further include a second media converter coupled to the second transceiver and configured to convert the communications from the second format to a third format used on the metropolitan network. The computing devices onboard the vehicle may be wirelessly enabled, and the system may further include a wireless access point onboard the vehicle that is coupled to the first transceiver and configured to communicate wirelessly with the computing device. The wireless access point may further be configured to convert wireless communications from the computing device from a wireless format to a wireline format prior to transmitting the communications to the first transceiver, and further configured to convert wireline communications from the first transceiver to the wireless format prior to transmitting the communications to the computing device.

According to various embodiments, the vehicle includes a passenger train car and the defined path is a train track. The communication line may be selected from a group consisting of one or more guide rails of the train track, a power rail, and an overhead power line. The second format may be a transit-specific format.

Another embodiment of a system includes means for receiving wireless communications from a computing device onboard a vehicle traveling a defined path in the transit environment, means for converting the wireless communications into a wireline format, means for transmitting wireline formatted communications to a communication line on or adjacent to the defined path, and means for receiving the wireline communications, converting the communications to a format supported by a metropolitan network, and transmitting the communications on the metropolitan network.

### BRIEF DESCRIPTION OF THE DRAWINGS

FIG. 1 illustrates a transit environment according to the prior art in which 802.11 antennae are positioned about every half mile and a metropolitan network access point is required every third hop in order to provide network communications between train cars and a metro network.

FIG. 2 illustrates another operating environment in accordance with the prior art in which cellular towers including WiMax (Worldwide Interoperability for Microwave Access) antennae are positioned near a transit path to provide for communications between train cars and the metro network.

FIG. 3 illustrates another operating environment in accordance with the prior art in which residences are in communication with the metro network via low voltage power lines which are connected to a metropolitan network using broadband over power line (BPL) technology.

FIGS. 4-5 illustrate an operating environment in accordance with an embodiment of the present invention, in which communication is provided between computing devices on a mobile vehicle and a metro network by transmitting data signals through a transit-based communication line that is on the path of travel of the mobile vehicle.

FIG. 6 illustrates one mechanism for connecting an onboard vehicle system with the transit-based communication line in accordance with the operating environment of FIG. 4.

FIG. 7 illustrates another mechanism for connecting an onboard vehicle system with the transit-based communication line in accordance with the operating environment of FIG. 4.

FIGS. 8-9 illustrate yet another operating environment in accordance with an embodiment of the present invention, in which a power (e.g., third) rail of a train track provides for communication between train cars and the metro network via a broadband over power line (BPL) transceiver and media converter (TMC).

FIG. 10 illustrates an embodiment of a mechanism connecting an onboard communication system of a train car to a power rail of the train track in accordance with the operating environment of FIG. 8.

FIGS. 11-12 illustrate another operating environment in accordance with an embodiment of the present invention, in which an overhead power line provides for communication between train cars and the metro network via a BPL transceiver and media converter.

FIG. 13 is a flowchart illustrating an algorithm with operations for carrying out hybrid communication in a transit environment in accordance with one embodiment of the present invention.

FIG. 14 illustrates a general purpose computing device upon which one or more aspects of embodiments of the present invention may be implemented.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Embodiments of the present invention generally relate to network communications. More specifically, embodiments of the present invention relate to providing communication in a transit environment. Embodiments generally provide communications between computing devices operating in a mobile vehicle and a metropolitan network. In general, the mobile vehicle travels on a path. A transit-based communication line is on, or adjacent to, the path. Typically, the transit-based communication line includes an electrical conductor. A communications access point onboard the vehicle is operable to communicably connect one or more computers onboard the vehicle with the communication line, which is communicably connected to the metro network.

According to at least one embodiment, the vehicle includes a train car that travels a path defined by a steel rail or an electrical power conductor. A wireless access point onboard the train car provides communications to and from computers onboard the train car. The steel rail or electrical power conductor provides connectivity to a fiber optic backbone network. In such embodiments, the steel rail or electrical line are used as the communication medium to provide broadband data services for applications such as Internet access.

In accordance with various embodiments, a transceiver and media converter (TMC) onboard the vehicle converts wireless protocol formatted signals to a transit-based protocol format and vice versa. Another transceiver and media converter external to the vehicle, and linking the communication line with a metro network, converts the transit-based signals to a metro network protocol and vice versa.

In some embodiments, the transit-based communication line includes train track rails, a power rail, or an overhead power line of an electrically powered train. The onboard transceiver and media converter can be communicatively connected to the transit-based communication line in various ways. In cases where the transit-based communication line includes guide rails of a train track, the connection can be steel wheels of the train or a dedicated electrically conductive structure. When a power rail of a train track serves as the communication line, a dedicated electrically conductive structure provides the connection between the onboard TMC and the power rail. In cases where an overhead power line serves as the transit-based communication line, an overhead electric connector connects the onboard TMC to the overhead power line.

According to one or more embodiments, a Rail Protocol is employed over the path-based communication line. According to one embodiment of the rail protocol, a packet wrapper is inserted around a metropolitan-network protocol, such as Ethernet or SONET, formatted signal for transmission over a steel rail or electrical power conductor. In one embodiment, the rail protocol is a Layer 2 “digital wrapper” or “frame” that involves encapsulation of the data as the data transits the steel rail between the metropolitan-network connection point and the vehicle. The rail protocol is responsible for performing Layer 2 functionality and may a variation or extension of the 802.3 Ethernet protocol. For example, Layer 2 Functionality provided by the rail protocol may specify carrier sense (e.g., whether the medium available for transmission or is it in use), collision detection (e.g., whether two devices simultaneously transmitted and overran one another), error correction (e.g., whether the frame was damaged in transit whether the frame should be retransmitted), and flow control (whether the receiver keep up with the transmitter or does the transmission rate need to be reduced). The rail protocol may be a variation or extension of a broadband over powerline (BPL) protocol.

Prior to describing one or more preferred embodiments of the present invention, definitions of some terms used throughout the description are presented.

### Definitions

A “module” is a self-contained functional component. A module may be implemented in hardware, software, firmware, or any combination thereof.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The terms “responsive” and “in response to” includes completely or partially responsive.

The term “computer-readable media” is media that is accessible by a computer, and can include, without limitation, computer storage media and communications media. Computer storage media generally refers to any type of computer-readable memory, such as, but not limited to, volatile, non-volatile, removable, or non-removable memory. Communication media refers to a modulated signal carrying computer-readable data, such as, without limitation, program modules, instructions, or data structures.

### Exemplary Systems

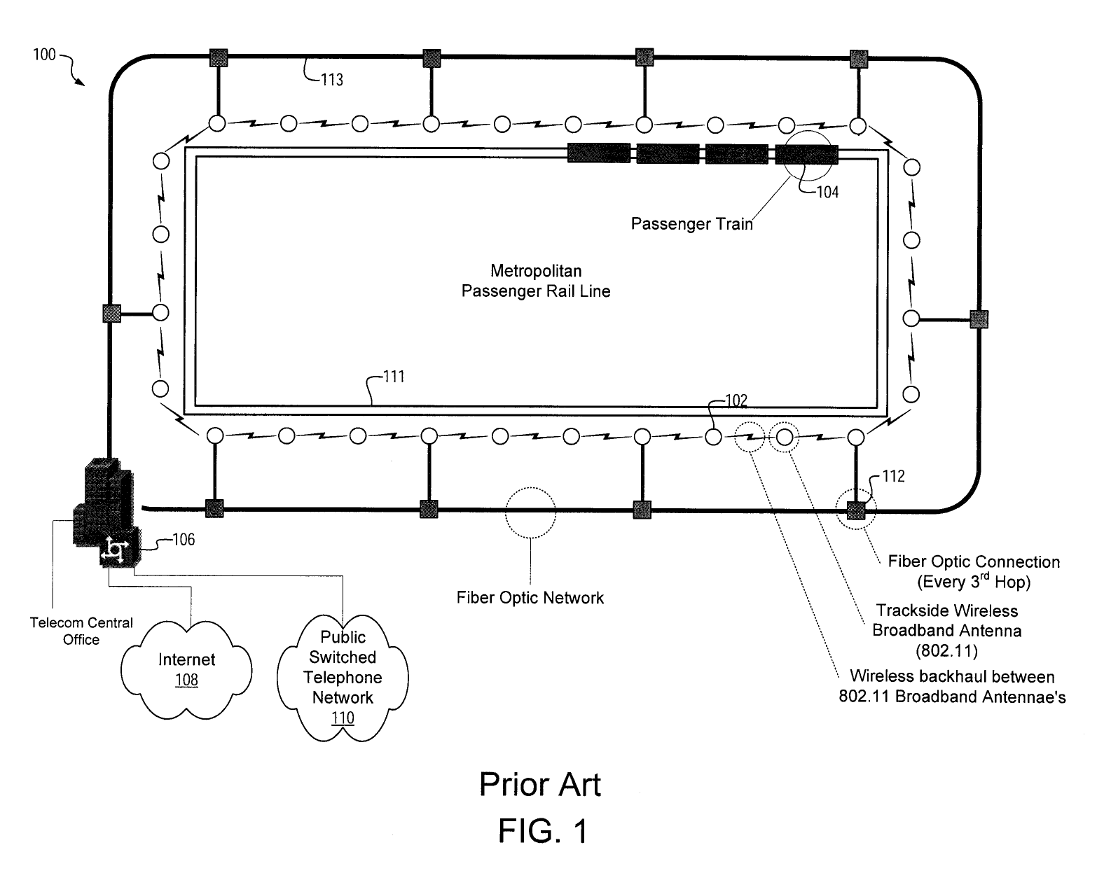

FIG. 1 illustrates a passenger train transit environment 100 according to the prior art that uses multiple 802.11 antennae 102 for providing communication between 802.11 wireless-enabled computers on passenger train cars 104 and a telecom central office 106. The telecom central office 106 provides communication between the transit environment 100 and one or more public networks, such as the Internet 108 and the public switched telephone network (PSTN) 110. Conventionally, the antennae are positioned at about every half mile from each other. The multiple antennae generally form a transit-based wireless backhaul network around train tracks 111 in transit environment 100, whereby communications can be transmitted, or hop, from one antenna to another.

Multiple fiber optic connection points 112 are located near the transit environment 100 to connect the 802.11 antennae with a fiber optic metropolitan or backbone network 113 interconnected with the central office 106. Conventionally, the fiber optic metro network 113 connects to the 802.11 wireless backhaul network at every third antenna 102 in the backhaul network via a fiber optic connection point 112. Conventionally, the fiber optic connection points 112 handle communications between the fiber optic network 113 and the wireless backhaul network by converting communications from the 802.11 wireless communication protocol to a fiber optic protocol such as Ethernet or SONET.

The 802.11 wireless communication protocol was originally developed for home and office use. In such home and office environments, distances are small. Obviously, communication distances are much larger in a transit environment 100. As a result, the antennae 102 must be spaced at about every half mile apart. One drawback to this conventional arrangement is the very high cost associated with building and deploying the antennae 102 at every half mile around the transit environment 100. If the transit environment 100 is very large geographically, it may be cost prohibitive to provide a wireless 802.11 antennae back haul network. In addition, fiber optic connection points 112 may be at varying distances from the antennae 102, and are typically in and around a metropolitan area, where it is often expensive and/or difficult to attach to the connection points 112.

Yet another problem that can arise in the environment of FIG. 1 relates to line-of-sight communication. Generally, the train cars 104 must have a line-of-sight view of the 802.11 antennae 102 in order to form a connection to the wider networks. If LOS is lost, the available bandwidth will be greatly reduced, or the connection will be completely dropped. The LOS may be lost in many situations, such as, the train going through a tunnel, around a hill or other obstacle, or through dense foliage or trees. As such, the communication configuration of FIG. 1 exhibits some drawbacks such as difficulty of deployment, high capital costs, and line-of-sight failure potential.

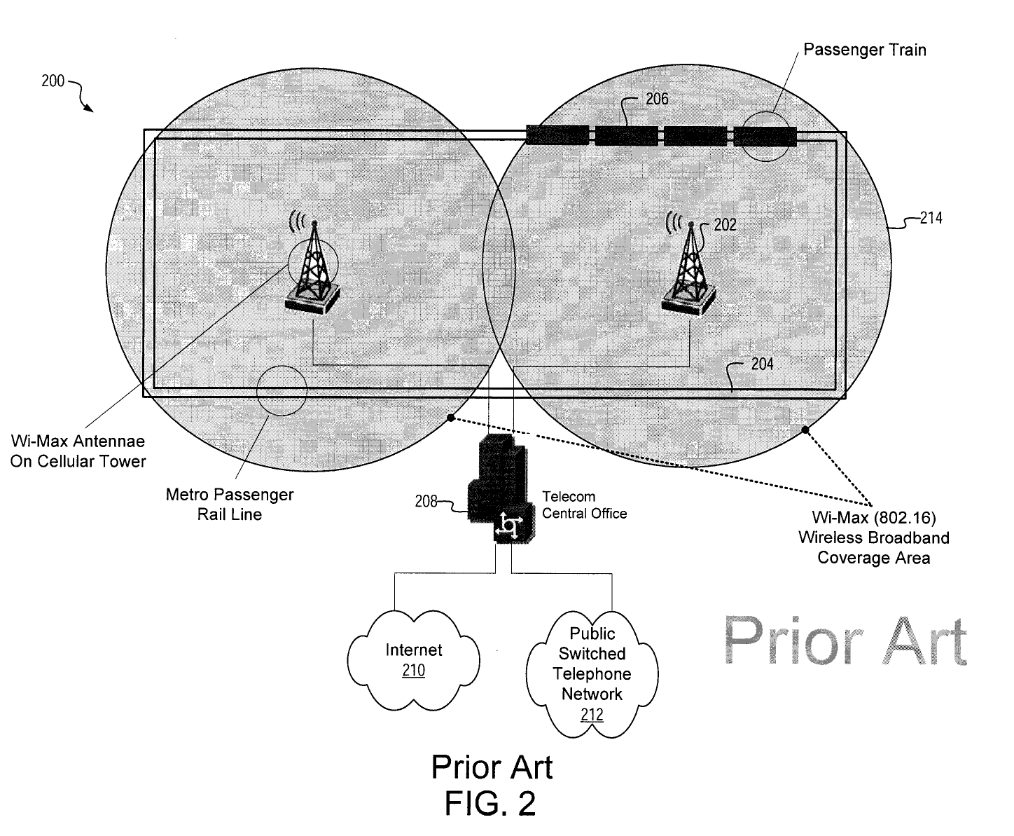

FIG. 2 illustrates another passenger train transit environment 200 in accordance with the prior art that uses multiple WiMax (Worldwide Interoperability for Microwave Access) antennae cellular towers 202. The WiMax (802.16) cellular towers 202 are positioned near the train track 204 to provide for communications between WiMax-enabled computers on the train cars 206 and a telecom central office 208, which provides connections to public networks such as the Internet 210 and the PSTN 212. The WiMax antennae on the cellular towers 202 have associated wireless broadband coverage areas 214, which are roughly circular. The WiMax coverage area distance is theoretically more than 10 miles, but in practice the WiMax coverage distance limited to about 6 miles.

The conventional transit-based communication configuration of FIG. 2 exhibits some problems that are similar to those of the environment of FIG. 1. For example, in order to wirelessly contact the WiMax antennae, the train cars 206 require a clear line-of-sight. If the train travels through a tunnel or an obstacle appears between the train and the WiMax antennae towers, communication links between the train cars 206 and the central office 208 will be dropped or bandwidth greatly reduced. The configuration of FIG. 2 also exhibits high capital costs associated with the building, deployment, and maintenance of the cellular towers 202 and equipment.

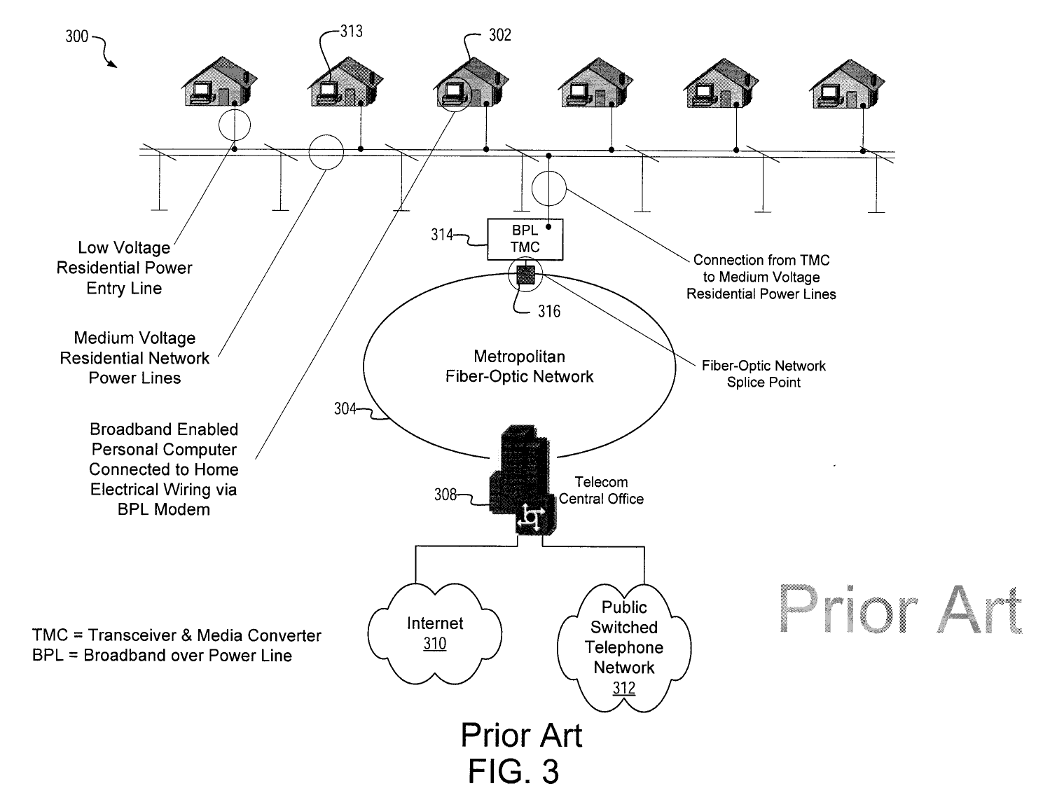

FIG. 3 illustrates a business or residential environment 300 in which broadband communications is provided between businesses or residences 302 and a metropolitan or backbone fiber optic network 304 via a power line 306. A central telecommunication office 308 interconnects the metro fiber optic network 304 and public networks, such as the Internet 310 and the PSTN 312. In this environment, broadband over power line (BPL) technology is used to link computers 313 at businesses or residences 302 to the fiber optic metro network 304.

The business or residence computers 313 typically communicate through a BPL modem. A BPL transceiver & media converter (TMC) 314 interconnects with the power line 306. The BPL TMC 314 is connected to a fiber optic network connection point 316 on the metro network 304. The BPL TMC 314 provides the necessary protocol conversions to facilitate communications between the power line 306 and the metro network 304. Obviously, in the environment of FIG. 3, the businesses and homes 302 are immobile and therefore connecting to the power line 306 is not very difficult. Connecting to a metro network in a transit environment where computers are based in mobile vehicles is more difficult. Embodiments described herein include systems and methods for providing hybrid communications in transit environments.

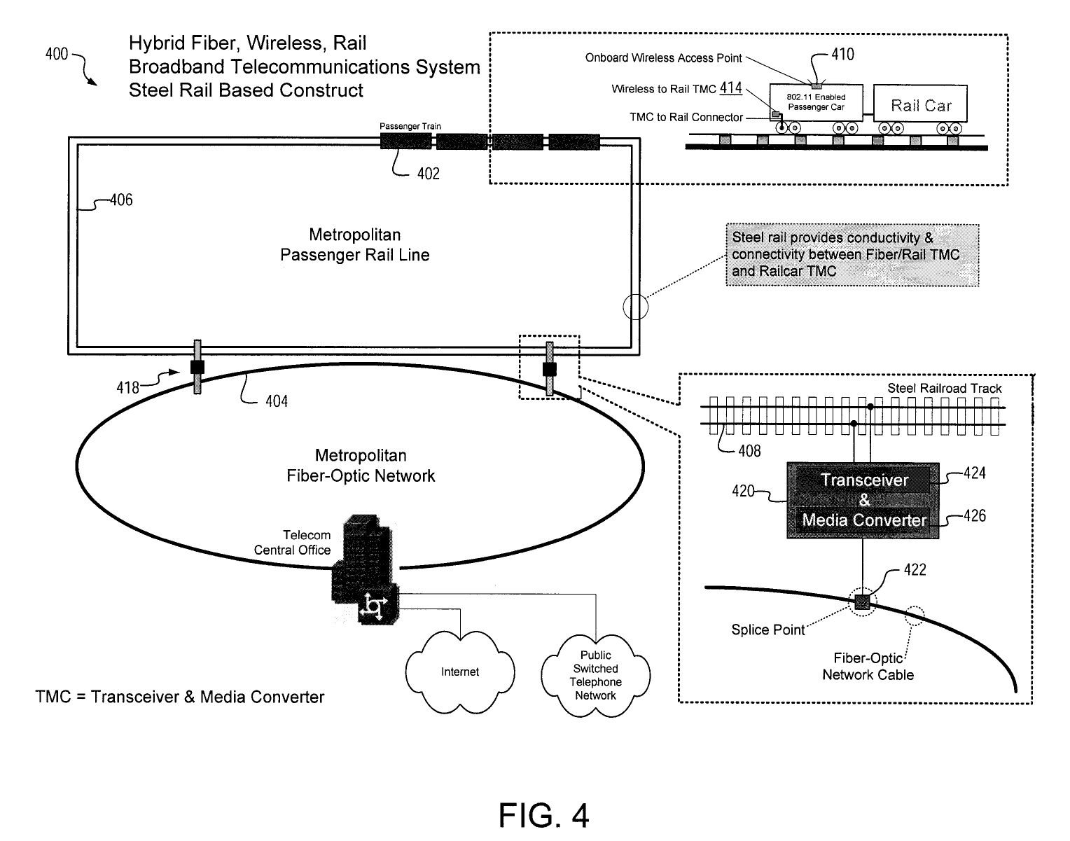

FIGS. 4-12 illustrate embodiments of systems and methods for providing communications in transit environments. These embodiments generally provide communications between computing devices operating in a mobile vehicle and a backbone or metropolitan network. In general, the mobile vehicle travels on a path. A transit-based communication line is on or adjacent to the path. Typically, the transit-based communication line includes an electrical conductor. The mobile vehicle may be any mobile vehicle that includes a communication link to the transit-based communication line. Although embodiments relate to wheeled passenger trains, the invention is not limited to wheeled passenger trains as the mode of transportation. The term “passenger” includes any rider in a vehicle, including travelers, guides, pilots, conductors, engineers or other workers. In addition, although described embodiments relate to travel via rail, the invention is not limited to rail travel. Many different variations and transit-based applications will be apparent to those skilled in the art that fall within the scope of the present invention.

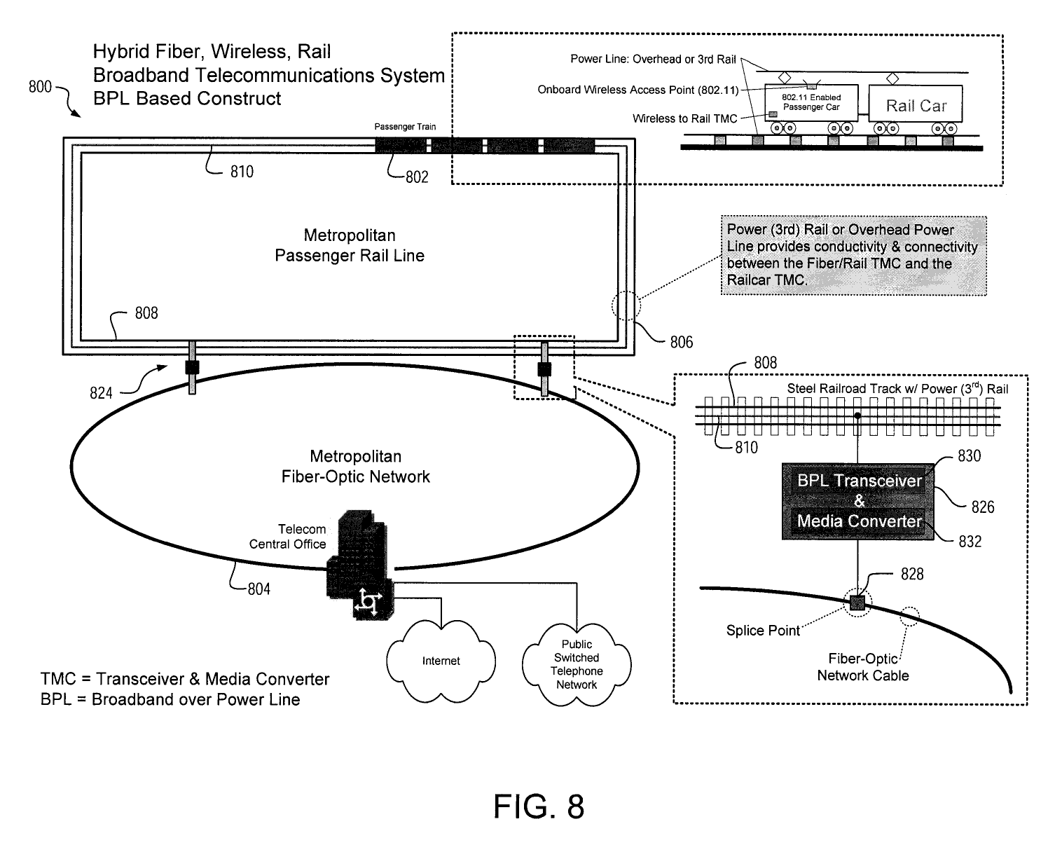

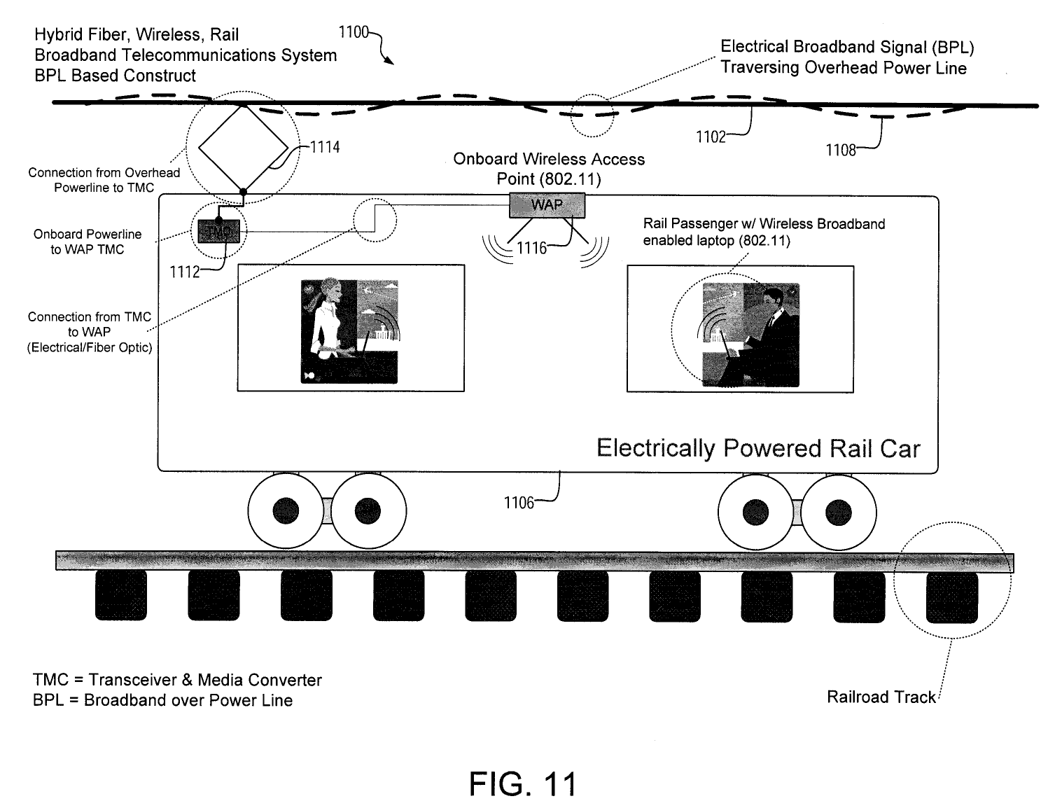

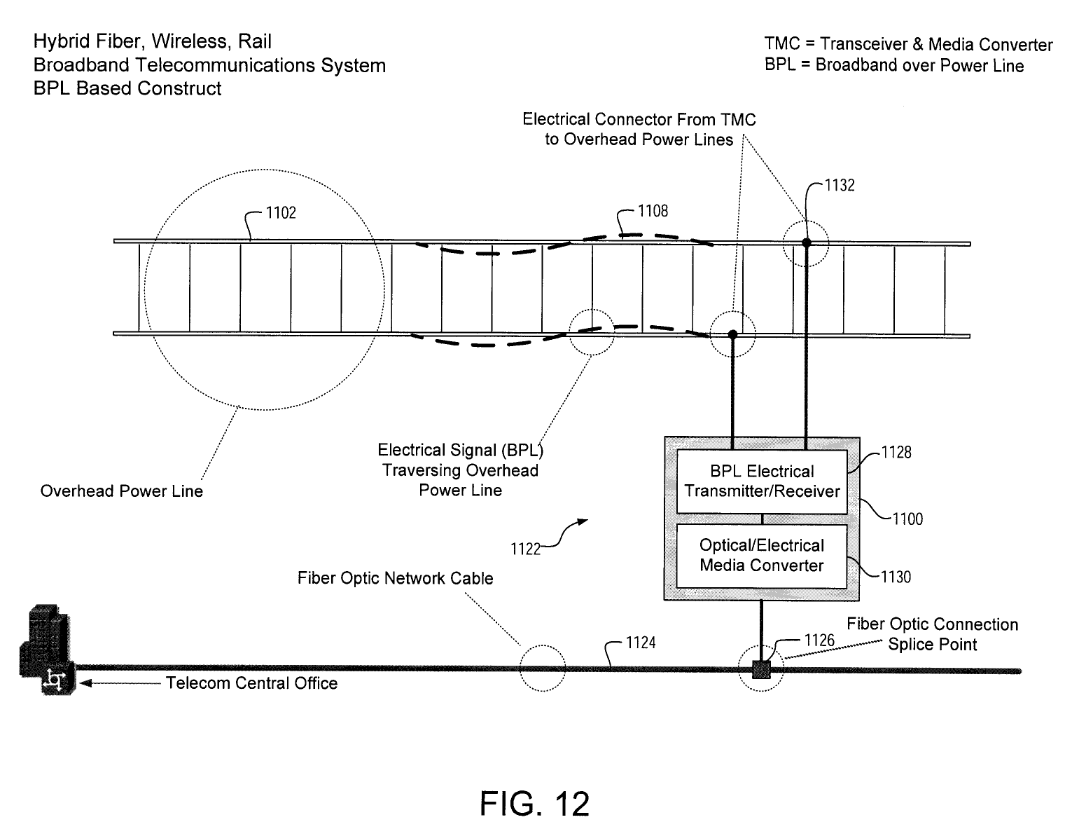

With further regard to the transit-based communication line that is on or adjacent to the path of the vehicle, the transit-based communication line may take many different forms. In the embodiments shown in FIGS. 4-7, the transit-based communication line is one both guide rails of a train track. In the embodiments of FIGS. 8-10, the communication line is a power rail of a train track. In the embodiments of FIGS. 11-12, the communication line is an overhead power line running above the path of a train track. These are merely a few illustrative examples, but the invention is not limited to these.

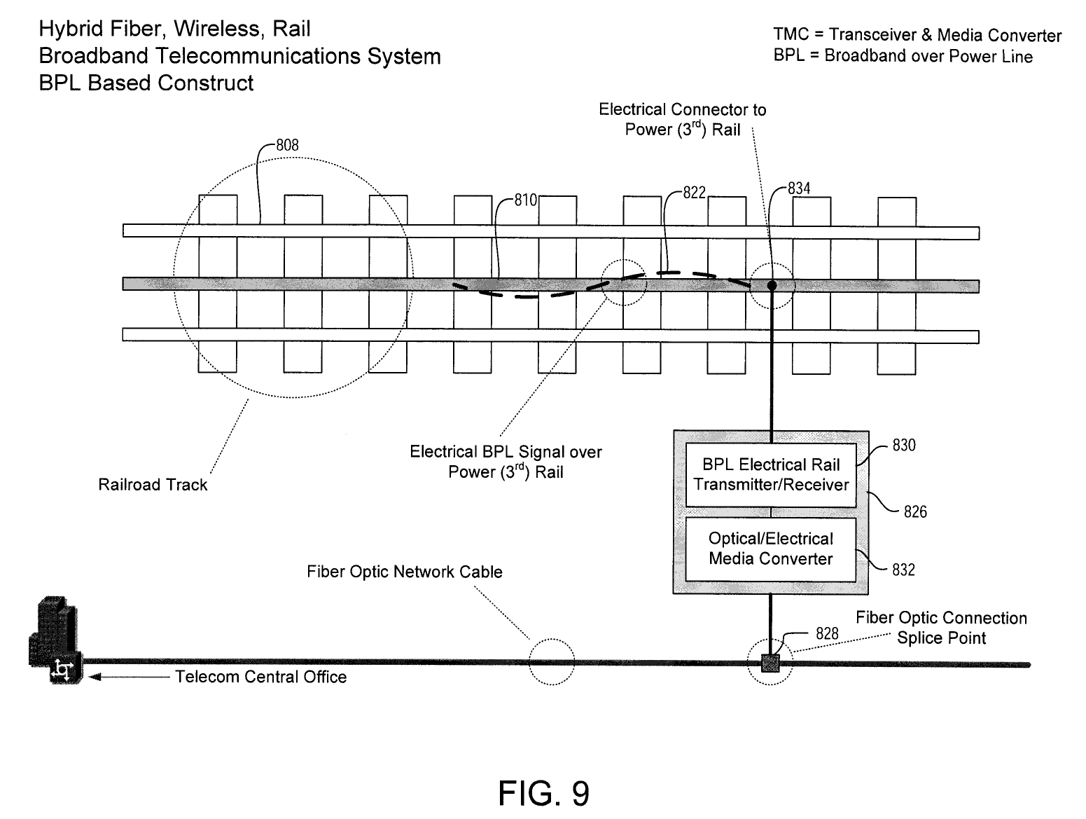

FIG. 4 illustrates a transit environment 400 in which embodiments of the invention can be employed to provide communications between the computing devices in a mobile vehicle, such as a passenger train car 402, and a backbone or metropolitan network 404. The passenger train cars 402 follow a path formed by a train track 406 that is composed of steel rails 408. In the embodiment of FIG. 4, the steel rails 408 are referred to as guide rails, to distinguish them from a power rail that may also be included in some transit environments. Such a power rail is shown in the embodiment of FIGS. 8-9, which are described in detail below.

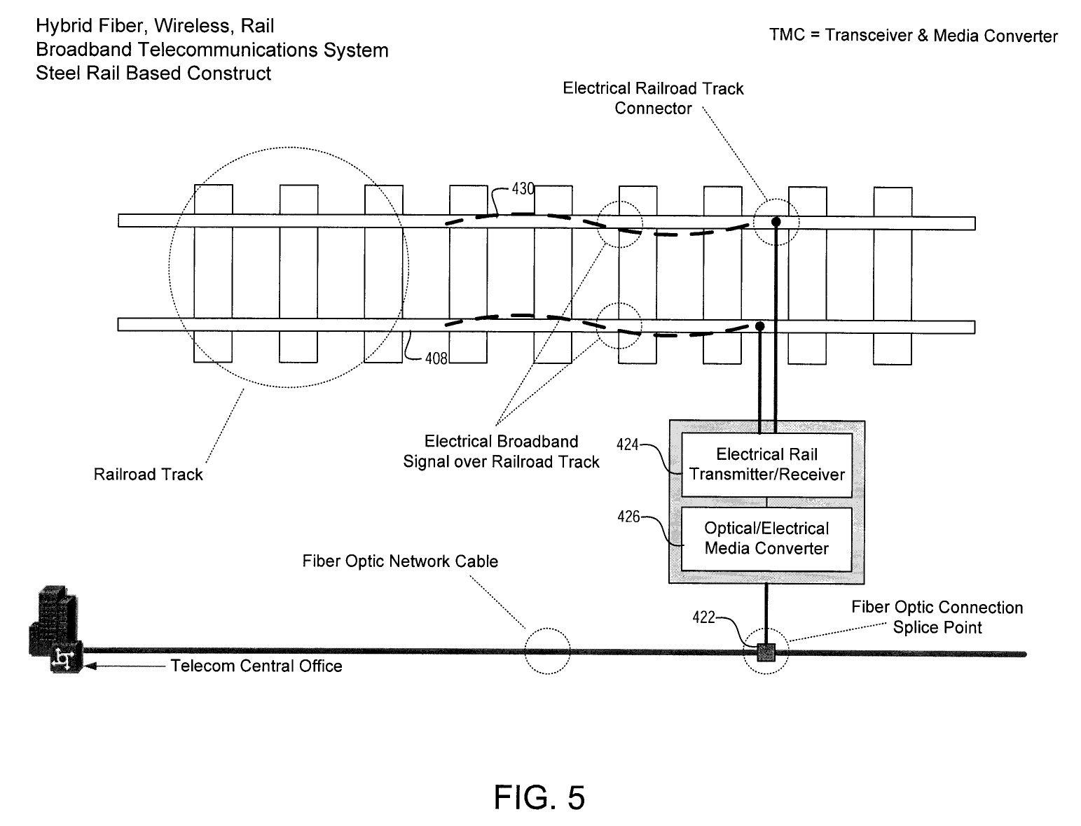

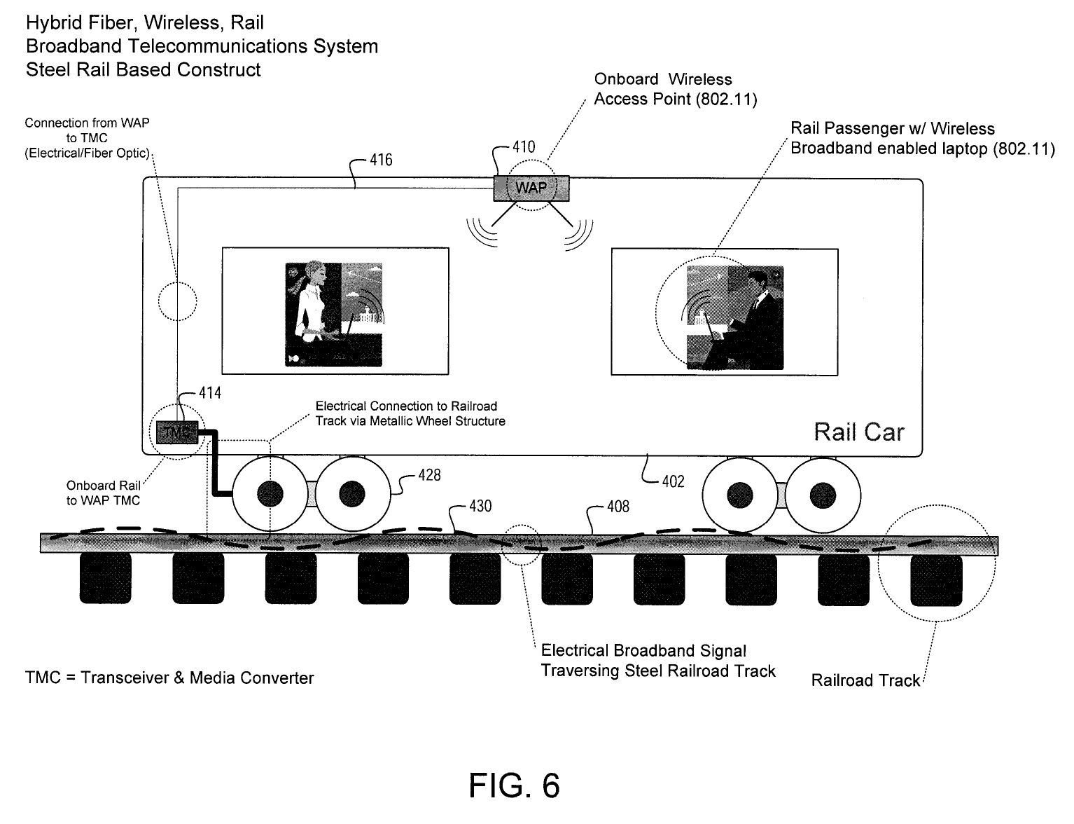

The embodiment of FIG. 4 is described in conjunction with FIGS. 5-7. One or more of the passenger cars 402 are equipped with an onboard wireless access point, such as an IEEE 802.11 wireless router 410. Embodiments described herein relate to IEEE 802.11 (e.g., 802.11a/b/g/n) wireless communications onboard the passenger car 402 between the wireless access point and the computing devices 412; however, it should be understood that other wireless communication protocols may be used. Computing devices 412 (FIG. 6) communicate wirelessly with the 802.11 wireless router 410. The 802.11 wireless router communicates with an onboard transceiver and media converter 414 through one or more onboard links 416, which may be electric wires or fiber or other communication medium. Data communicated over the onboard links 416 is communicated according to a wireline protocol, such as, but not limited to, the IEEE 802.3 protocol.

In various embodiments, the guide rails 408, being electrical conductors, are used as a communication medium to carry data to and from the passenger train 402. Data from the passenger car 402 is communicated onto the guide rails 408, and data received from the guide rails 408, by the onboard TMC 414. Data carried on the guide rails 408 is in a transit-based format and/or abides by a transit-based protocol that is recognized by the onboard TMC 414. The onboard TMC 414 is operable to reformat the wireline protocol formatted data received from the wireless access point 410 into the transit-based format and/or protocol and send the transit-based formatted data on the rails 408. The onboard TMC 414 is also operable to receive data in the transit-based format from the rails 408, reformat the data into the wireline protocol format, and transmit the wireline protocol formatted data on the onboard links 416.

Although embodiments described herein show the onboard TMC 414 and the wireless access point 410 as separate devices, it will be understood that the onboard TMC 414 and the wireless access point 410 could be integrated into a single device. In such embodiments, the format and protocol conversions performed by the onboard TMC 414 would be performed by the single device, which would also communicate wirelessly with the computing devices 412.

One or more connection points 418 are provided that connect the track 406 to the metro network 404. In the illustrated embodiment, each connection point 418 includes one or more devices, such as another TMC 420 and a fiber optic splice point 422. The TMC 420 includes a transceiver 424 and a media converter 426. In one embodiment shown in FIG. 5, the TMC 420 is coupled to the rails 408 by electrical railroad track connectors 428. Via the connectors 428, the TMC transceiver 424 receives and transmits electrical broadband signals 430 propagated over the rails 408. The media converter 426 of the TMC 420 may include an optical and/or electrical media converter. The media converter 426 converts data from the transit-based protocol to the protocol used on the metro network 404 and vice versa. In one embodiment, the media converter 426 converts transit-based protocol formatted data from the rails 408 into Ethernet or SONET protocol prior to transmitting the Ethernet or SONET formatted data to the fiber optic connection point 422. Similarly, the media converter 426 converts Ethernet or SONET protocol formatted signals received from the metro network 404 into transit-based protocol formatted signals before they are transmitted over the rails 408 by the transceiver 424.

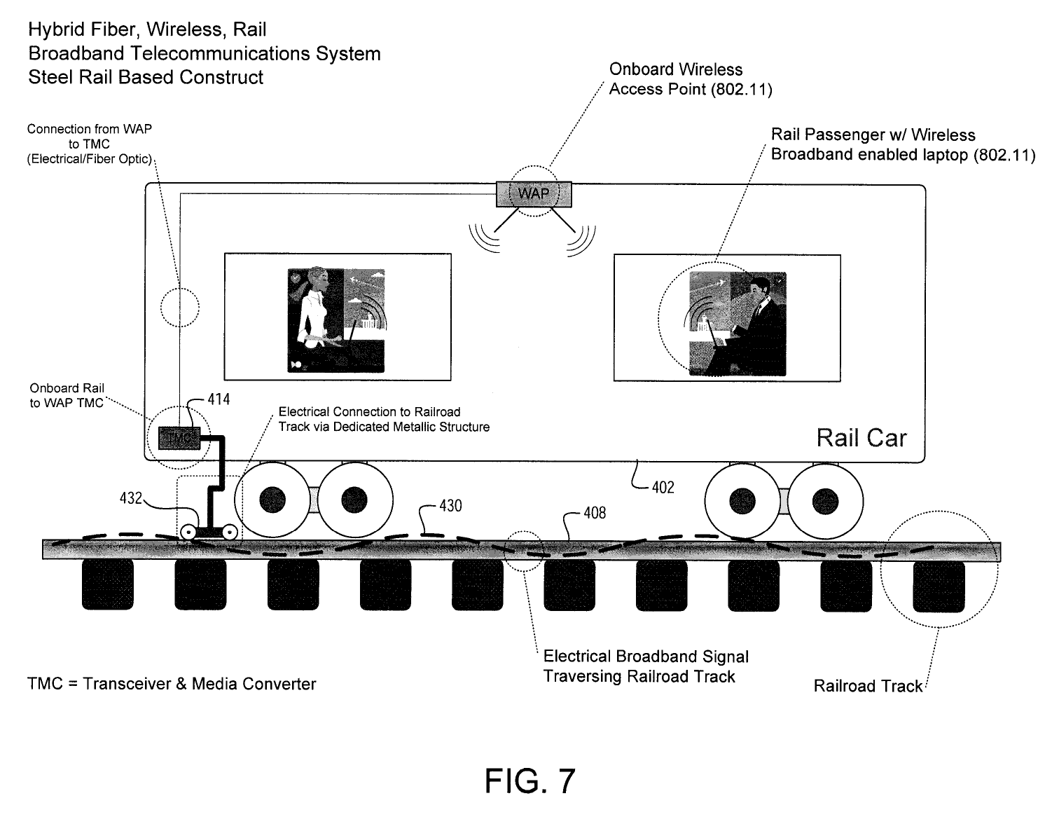

FIGS. 6-7 illustrate two different mechanisms for connecting the onboard TMC 414 to the rails 408. In FIG. 6, the onboard TMC 414 is connected electrically to steel wheels 428 of the train car 402. In this configuration, the steel wheels 428 form a continuous electrical connection between the onboard TMC 414 and the steel rails 408.

In FIG. 7, a dedicated electrically conductive structure 432 communicatively couples the onboard TMC 414 to the guide rails 408. The dedicated electrically conductive structure 432 is typically made of a metal. In some embodiments, such as that shown in FIG. 7, the dedicated structure 432 includes one or more metallic wheels that rest on the rails 408 and roll on the rails 408 when the passenger car 402 moves.

FIG. 8 illustrates another transit environment 800 in which embodiments of the invention can be employed to provide communications between the computing devices in a mobile vehicle, such as a passenger train car 802, and a backbone or metropolitan network 804. As in the environment of FIG. 4, the passenger train cars 802 follow a path formed by a train track 806 that is composed of steel guide rails 808. Unlike the environment shown in FIG. 4, the transit environment 800 includes a third power rail 810, which is used for network communication.

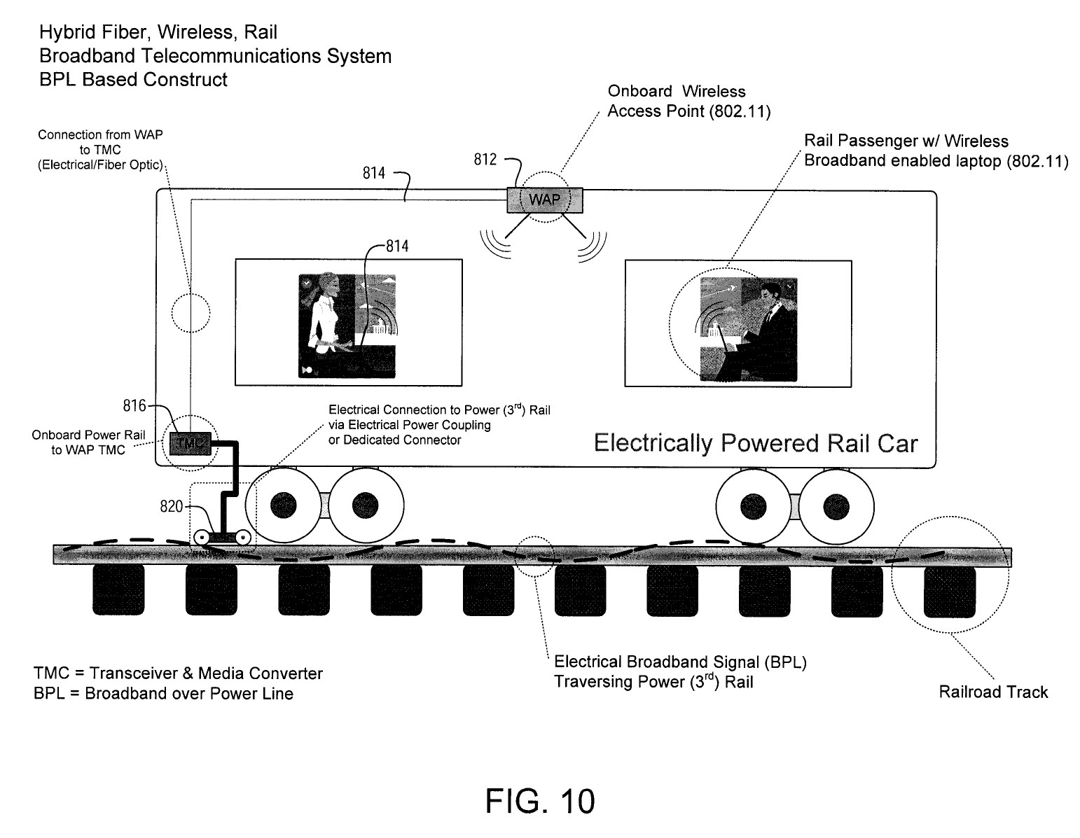

One or more of the passenger cars 802 are equipped with an onboard wireless access point, such as an IEEE 802.11 wireless router 812. Computing devices 814 (FIG. 10) communicate wirelessly with the 802.11 wireless router 812. The 802.11 wireless router communicates with an onboard transceiver and media converter (TMC) 816 through one or more onboard links 818, which may be electric wires or fiber or other communication medium. Data communicated over the onboard links 818 is communicated according to a wireline protocol, such as IEEE 802.3. As discussed above, the onboard TMC 816 and the wireless access point 812 need not be separate devices, but can be combined in a single device.

An electrical connection is formed between the onboard TMC 816 and the power rail 810 by a dedicated electrically conductive structure 820. Data from the passenger car 802 is communicated onto the power rail 810, and data is received from the power rail 810, by the onboard TMC 816. Data carried on the power rail 810 is encoded in a BPL signal 822. The onboard TMC 816 is operable to reformat wireline protocol formatted data received from the wireless access point 812 into a format suitable for the BPL signal 822. The format of the data in the BPL signal 822 may be a transit-based format recognized by the onboard TMC 816. The onboard TMC 816 is also operable to receive BPL signals 822 from the power rail 810, reformat the data into the wireline protocol format, and transmit the wireline protocol formatted data on the onboard links 818.

One or more connection points 824 are provided that connect the track 806 to the metro network 804. In the embodiment of FIG. 8, each connection point 824 includes one or more devices, such as a BPL TMC 826 and a fiber optic splice point 828. The BPL TMC 825 includes a transceiver 830 and a media converter 832. In one embodiment shown in FIG. 9, the TMC 826 is coupled to the power rail 810 by an electrical power rail connector 834. Via the connector 834, the BPL TMC transceiver 830 receives and transmits BPL signals 822 propagated over the power rail 810. The media converter 832 of the TMC 826 may include an optical and/or electrical media converter. The media converter 832 converts BPL signals 822 to a protocol used on the metro network 804 and vice versa. In one embodiment, the media converter 832 converts BPL signals 822 from the power rail 810 into Ethernet or SONET protocol prior to transmitting the Ethernet or SONET formatted signals to the fiber optic connection point 828. Similarly, the media converter 832 converts Ethernet or SONET protocol formatted signals received from the metro network 804 into BPL signals 822 before they are transmitted over the power rail 810 by the transceiver 830.

FIGS. 11-12 illustrate another operating environment 1100 in accordance with an embodiment of the present invention, in which an overhead power line 1102 serves as a transit-based communication line. Via the overhead power line 102, computing devices 1104 in an electrically powered train car 1106 and the metro network can communicate using BPL signals 1108. The BPL signals 1108 propagate through the overhead power line 1102 between an external BPL TMC 1110 and an onboard TMC 1112. The onboard TMC 1112 is connected to the overhead power line 1102 with an overhead power line connector 1114, which is electrically conductive. As in the previously discussed environments, computing devices 1104 communicate wirelessly with an onboard wireless access point 1116, which communicates with the onboard TMC 1112 via an onboard communication link 1118. As discussed above, the onboard TMC 1112 may be integrated with the onboard wireless access point 1116 into a single TMC device.

Data from the wireless access point 1116 is communicated onto the overhead power line 1102, and data is received from the overhead power line 1102, by the onboard TMC 1112. Data carried on the overhead power line 1102 is encoded in a BPL signal 1108 in a transit-based protocol. The onboard TMC 1112 is operable to reformat wireline protocol (e.g., 802.3) formatted data received from the wireless access point 1116 into a format suitable for the BPL signal 1108. The format of the data in the BPL signal 1108 may be a transit-based format recognized by the onboard TMC 1112. The onboard TMC 1112 is also operable to receive BPL signals 1108 from the overhead power line 1102, reformat the data into the wireline protocol format, and transmit the wireline protocol formatted data on the onboard communication link 1118.

One or more connection points 1122 are provided that connect the overhead power line 1102 to a metropolitan network, such as fiber optic metro network 1124. In the embodiment of FIG. 11, each connection point 1122 includes one or more devices, such as the BPL TMC 1110 and a fiber optic splice point 1126. The BPL TMC 1110 includes a BPL transceiver 1128 and a media converter 1130. The BPL TMC 1110 is coupled to the overhead power line(s) 1102 by one or more electrical overhead power line connector(s) 1132. Via the connector(s) 1132, the BPL TMC transceiver 1128 receives and transmits BPL signals 1120 propagated over the overhead power line 1102. The media converter 1130 of the BPL TMC 1110 may include an optical and/or electrical media converter for converting BPL signals 1120 to a protocol used on the metro network 1124 and vice versa. In one embodiment, the media converter 1130 converts BPL signals 1108 from the overhead power line 1102 into Ethernet or SONET protocol prior to transmitting the Ethernet or SONET formatted signals to the fiber optic connection point 1126. Similarly, the media converter 1130 converts Ethernet or SONET protocol formatted signals received from the metro network 1124 into BPL signals 1108 before they are transmitted over the overhead power line 1102 by the transceiver 1128.

### Exemplary Operations

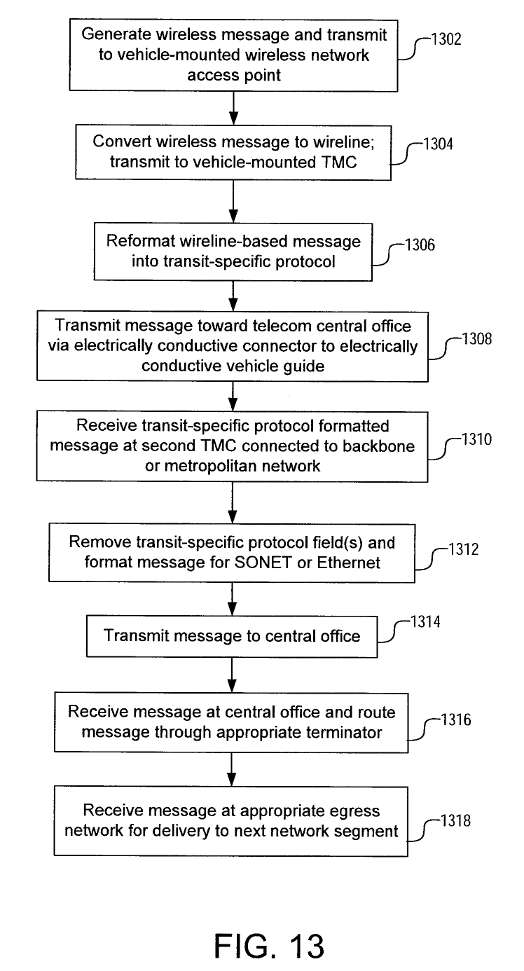

FIG. 13 is a flowchart illustrating a algorithm 1300 with operations for carrying out hybrid communication in a transit environment in accordance with one embodiment of the present invention. In this embodiment, it is assumed that a computing device in a passenger vehicle is wirelessly enabled and the vehicle travels on a path with a communication line on the path or adjacent thereto.

In a generating operation 1302, a message (e.g., a request message) is generated by a computing device on the vehicle. The message may be generated by any of numerous types of portable computing devices, such as, but not limited to, PDAs, cell phones, handheld computers, and laptop computers. The generating operation 1302 packetizes the message into an Internet protocol format and encapsulates the message into a wireless format, such as 802.11 format. The message is then transmitted wirelessly to a wireless access point onboard the vehicle.

In a converting operation 1304, the message is received by the wireless access point and converted into a form that is in accordance with a wireline protocol, such as 802.3. The wireline protocol formatted message is transmitted to an onboard transceiver and media converter (TMC). The onboard TMC reformats the received message in a reformatting operation 1306. In one embodiment of the reformatting operation 1306, the TMC encapsulates the wireline protocol formatted message with transit-specific protocol fields used in the transit environment. In a railway environment, the transit-specific protocol is a rail protocol (RP).

According to one or more embodiments, a Rail Protocol is employed over the path-based communication line. According to one embodiment of the rail protocol, a packet wrapper is inserted around a metropolitan-network protocol, such as Ethernet or SONET, formatted signal for transmission over a steel rail or electrical power conductor. In one embodiment, the rail protocol is a Layer 2 “digital wrapper” or “frame” that involves encapsulation of the data as the data transits the steel rail between the metropolitan-network connection point and the vehicle. The rail protocol is responsible for performing Layer 2 functionality and may be a variation or extension of the 802.3 Ethernet protocol. For example, Layer 2 Functionality provided by the rail protocol may specify carrier sense (e.g., whether the medium available for transmission or is it in use), collision detection (e.g., whether two devices simultaneously transmitted and overran one another), error correction (e.g., whether the frame was damaged in transit and should be retransmitted), and flow control (whether the receiver can keep up with the transmitter or does the transmission rate need to be reduced). The rail protocol may be a variation or extension of a broadband over powerline (BPL) protocol.

The TMC encodes a signal to include the transit-specific protocol formatted message to prepare the message for transmission toward the metro network. In a transmitting operation 1308, the TMC transmits the message toward the telecom central office via an electrically conductive connector to the transit-based communication line. The electrically conductive connector is a connector that electrically couples the TMC with the communication line, such as steel rail car wheels, power line connector, or a dedicated mechanical connection device. and sends the signal over the communication line (e.g., steel guide rail, power rail, or overhead power line). The message traverses the communication line to the nearest fiber optic connection point.

In a receiving operation 1310, the message in the transit-based protocol format is received by another TMC at the fiber optic connection point that couples the transit-based communication line to a fiber optic metro network. In a removing operation 1312, the TMC removes the transit-specific protocol field(s) and formats the message for SONET or Ethernet. This typically involves encapsulating the message with SONET or Ethernet packets.

The TMC then transmits the message to the central office in a transmitting operation 1314. In a receiving operation 1316, the central office receives the message and routes the message through an appropriate terminator. For example, the message may be routed through an Add/Drop Multiplexer or an Ethernet switch or router. The message is then received at the appropriate egress network (e.g., Internet or PSTN) in a receiving operation 1318, which then delivers the message to the next segment of the network.

The foregoing discussion of algorithm 1300 illustrates transmittal of data from a computer onboard a vehicle in a transit system, and steps in the process of propagating the message through the various portions of the network to the final destination. Messages that are sent to the onboard computer from the metropolitan go through roughly the same steps in a reverse process.

### Exemplary Computing Device

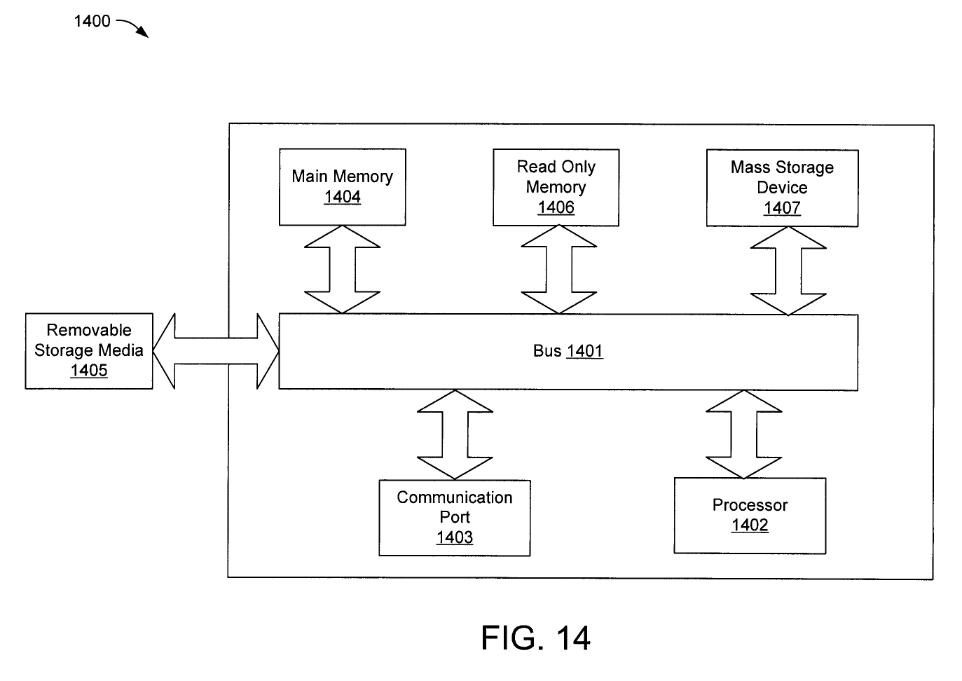

FIG. 14 is a schematic diagram of a computing device 1400 upon which embodiments of the present invention may be implemented and carried out. As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware.

According to the present example, the computing device 1400 includes a bus 1401, at least one processor 1402, at least one communication port 1403, a main memory 1404, a removable storage media 1405, a read only memory 1406, and a mass storage 1407. Processor(s) 1402 can be any know processor, such as, but not limited to, an Intel® Itanium® or Itanium 2® processor(s), AMD® Opteron® or Athlon MP® processor(s), or Motorola® lines of processors. Communication port(s) 1403 can be any of an RS-232 port for use with a modem based dialup connection, a 10/100 Ethernet port, a Gigabit port using copper or fiber, or a USB port. Communication port(s) 1403 may be chosen depending on a network such a Local Area Network (LAN), Wide Area Network (WAN), or any network to which the computing device 1400 connects. The computing device 1400 may be in communication with peripheral devices (not shown) such as, but not limited to, printers, speakers, cameras, microphones, or scanners.

Main memory 1404 can be Random Access Memory (RAM), or any other dynamic storage device(s) commonly known in the art. Read only memory 1406 can be any static storage device(s) such as Programmable Read Only Memory (PROM) chips for storing static information such as instructions for processor 1402. Mass storage 1407 can be used to store information and instructions. For example, hard disks such as the Adaptec® family of SCSI drives, an optical disc, an array of disks such as RAID, such as the Adaptec family of RAID drives, or any other mass storage devices may be used.

Bus 1401 communicatively couples processor(s) 1402 with the other memory, storage and communication blocks. Bus 1401 can be a PCI/PCI-X, SCSI, or USB based system bus (or other) depending on the storage devices used. Removable storage media 1405 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A method for providing network communication in a transit environment including one or more passenger vehicles, the method comprising:
receiving a wireless communication at a wireless access point on a passenger vehicle traveling on a defined path;
reformatting the wireless communication into a wireline communication; and
transmitting the wireline communication onto a path-based communication line that is adjacent to or on the defined path, wherein the wireline communication is transmitted to a network connection point that couples the path-based communication line to a metropolitan network, and wherein the network connection point is operable to transmit the communication onto the metropolitan network.

2. The method as recited in claim 1, further comprising reformatting the wireline communication from a wireline protocol into a transit environment protocol.

3. The method as recited in claim 2, wherein the transit environment protocol is a variation of a broadband over power line (BPL) protocol.

4. The method as recited in claim 2, wherein reformatting the wireline communication into the transit environment protocol comprises encapsulating the wireline communication in one or more transit environment protocol data fields.

5. The method as recited in claim 4, further comprising:
reformatting the transit environment protocol formatted communication into a metropolitan network protocol formatted communication; and
transmitting the metropolitan network protocol formatted communication on the metropolitan network.

6. The method as recited in claim 5, further comprising removing the one or more transit environment protocol data fields from the transit environment protocol formatted message.

7. The method as recited in claim 5, wherein the metropolitan network protocol is selected from a group consisting of SONET and Ethernet.

8. The method as recited in claim 1, wherein the wireless access point comprises a device that supports an IEEE 802.11 wireless communication standard.

9. The method as recited in claim 1, wherein the passenger vehicle comprises a passenger train car traveling on a train track that defines the path.

10. The method as recited in claim 9, wherein transmitting the wireline communication via the path-based communication line comprises transmitting the wireline communication via a path-based communication line selected from a group consisting of:
one or more guide rails of the train track;
a power rail of the train track;
an overhead power line.

11. The method as recited in claim 9, wherein transmitting the wireline communication onto the path-based communication line comprises transmitting the wireline communication via an electrical conductor coupled to the path-based communication line.

12. The method as recited in claim 11 wherein the electrical conductor is selected from a group consisting of a dedicated metallic structure, one or more wheels of the train car, and an overhead power line.

13. A system for providing communication between a metropolitan network and communication devices onboard a vehicle in a transit environment, wherein the vehicle follows a defined path within the transit environment, the system comprising:
a communication line configured to carry electrical communications to and from the vehicle, the communication line being on or adjacent to the defined path;
a first transceiver onboard the vehicle configured to receive communications sent from a computing device onboard the vehicle and transmit the communications on the communication line; and
a second transceiver coupled to the communication and a metropolitan network, the transceiver configured to receive communications transmitted over the communication line and transmit the communications on the metropolitan network.

14. The system as recited in claim 13, further comprising a first media converter coupled to the first transceiver and configured to convert the communications from a first format used onboard the vehicle to a second format used on the communication line.

15. The system as recited in claim 14, further comprising a second media converter coupled to the second transceiver and configured to convert the communications from the second format to a third format used on the metropolitan network.

16. The system as recited in claim 13, wherein the computing devices onboard the vehicle are wirelessly enabled, the system further comprising a wireless access point onboard the vehicle, the wireless access point coupled to the first transceiver and configured to communicate wirelessly with the computing device.

17. The system as recited in claim 16 wherein the wireless access point is further configured to convert wireless communications from the computing device from a wireless format to a wireline format prior to transmitting the communications to the first transceiver, and further configured to convert wireline communications from the first transceiver to the wireless format prior to transmitting the communications to the computing device.

18. The system as recited in claim 14, wherein the vehicle is a passenger train car, the defined path is a train track, and the communication line is selected from a group consisting of one or more guide rails of the train track, a power rail, and an overhead power line.

19. The system as recited in claim 18, wherein the second format is a transit-specific format.

20. A system for providing communications to and from computing devices communicating with a wireless format in a transit environment, the system comprising:
means for receiving wireless communications from a computing device onboard a vehicle traveling a defined path in the transit environment;
means for converting the wireless communications into a wireline format;
means for transmitting wireline formatted communications to a communication line on or adjacent to the defined path;
means for receiving the wireline communications, converting the communications to a format supported by a metropolitan network, and transmitting the communications on the metropolitan network.
